(19) United States
(12) Patent Application Publication
(10) Pub. No.: US 2025/0355927 A1
(43) Pub. Date: Nov. 20, 2025

(54) PROMPT GENERATING APPARATUS

(71) Applicant: KYOCERA Document Solutions Inc., Osaka (JP)

(72) Inventors: Kenichi Katsura, Osaka (JP); Yuya Okazaki, Osaka (JP); Naomichi Higashiyama, Osaka (JP)

(21) Appl. No.: 19/205,815

(22) Filed: May 12, 2025

(30) Foreign Application Priority Data
May 20, 2024 (JP) 2024-082126

(51) Int. Cl. G06F 16/532; G06T 11/00

(52) U.S. Cl. CPC G06F 16/532; G06T 11/00

(57) ABSTRACT

A prompt generating apparatus includes a user prompt acquiring unit, a system prompt selecting unit, an input prompt generating unit, and a generated image acquiring unit. The user prompt acquiring unit is configured to acquire a user prompt inputted by a user. The system prompt selecting unit is configured to select a system prompt preset for an image usage specified by the user among system prompt presets that include image property setting values that have been selected of plural image property items for specific image usages. The input prompt generating unit is configured to generate an input prompt on the basis of the user prompt and the image property setting values in the selected system prompt preset. The generated image acquiring unit is configured to acquire a generated image corresponding to the input prompt using an image generation model.

### CROSS-REFERENCE TO RELATED APPLICATIONS

This application relates to and claims priority rights from Japanese Patent Application No. 2024-082126, filed on May 20, 2024, the entire disclosures of which are hereby incorporated by reference herein.

### BACKGROUND

### 1. Field of the Present Disclosure

The present disclosure relates to a prompt generating apparatus.

### 2. Description of the Related Art

In a machine-learned image generation model, an inputted text (prompt) is converted to a characteristic vector, and an image corresponding to the characteristic vector is generated.

In general, when a user acquires a generated image desired by the user using an image generation model as mentioned, the user includes an adjustment prompt (setting values of items such as brightness, preciseness, and composition, i.e. modifiers) in a prompt to be inputted to the image generation model in order to acquire a generated image that has a property required by the user.

Therefore, every time when image generation is performed, a user is required to specify a proper adjustment prompt to cause to generate an image with desired image properties, and it is burdensome.

### SUMMARY

A prompt generating apparatus according to an aspect of the present disclosure includes a user prompt acquiring unit, a system prompt selecting unit, an input prompt generating unit, and a generated image acquiring unit. The user prompt acquiring unit is configured to acquire a user prompt inputted by a user. The system prompt selecting unit is configured to select a system prompt preset for an image usage specified by the user among system prompt presets that include image property setting values that have been selected of plural image property items for specific image usages. The input prompt generating unit is configured to generate an input prompt on the basis of the user prompt and the image property setting values in the selected system prompt preset. The generated image acquiring unit is configured to acquire a generated image corresponding to the input prompt using an image generation model.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of a prompt generating apparatus according to an embodiment of the present disclosure;

FIG. 2 shows a diagram that indicates an example of system prompt definition data 13a;

FIG. 3 shows a diagram that indicates an example of a system prompt preset for an object type;

FIG. 4 shows a diagram that indicates an example of a system prompt preset for an image usage;

FIG. 5 shows a flowchart that explains generation of an input prompt for image generation in the prompt generating apparatus 1 shown in FIG. 1; and

FIG. 6 shows a flowchart that explains registration of a system prompt preset in the prompt generating apparatus 1 shown in FIG. 1.

### DETAILED DESCRIPTION

Hereinafter, an embodiment according to an aspect of the present disclosure will be explained with reference to drawings.

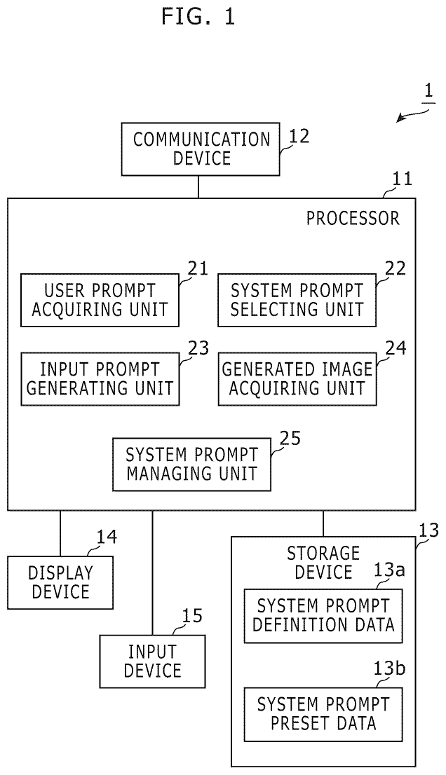

FIG. 1 shows a block diagram that indicates a configuration of a prompt generating apparatus according to an embodiment of the present disclosure. The prompt generating apparatus 1 is an electronic apparatus such as multi function peripheral or personal computer, and includes a processor 11 as a computer, a communication device 12, a storage device 13, a display device 14, and an input device 15.

The communication device 12 is a device (network interface or the like) capable of data communication with another device through a computer network such as Internet or intranet.

Further, the storage device 13 is a nonvolatile storage device such as flash memory or hard disk and stores a program and data. In the storage device 13, system prompt definition data 13a, system prompt preset data 13b and the like have been stored.

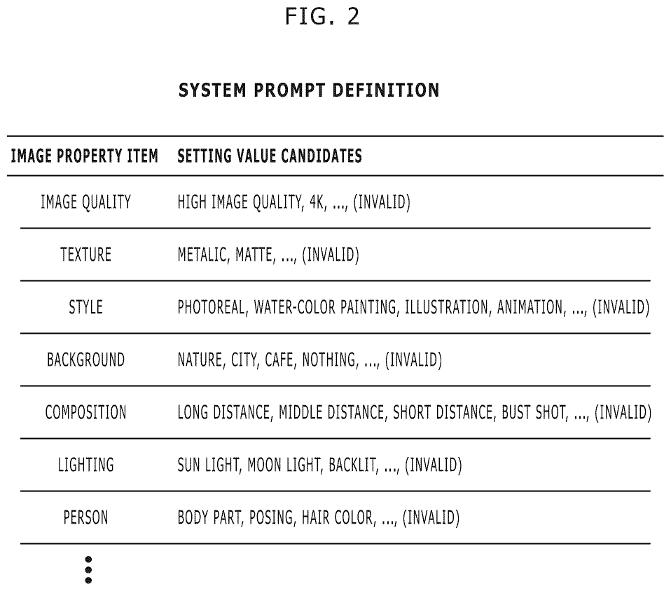

FIG. 2 shows a diagram that indicates an example of system prompt definition data 13a. As shown in FIG. 2, for example, the system prompt definition data 13a includes an image property item and a setting value candidate group of this image property for each of plural image property items so as to associate the image property item and the setting value candidate group with each other. The system prompt definition data 13a is used for generation of the system prompt preset data 13b. A system prompt is an adjustment prompt as mentioned, and the system prompt preset is a data set that specifies a single setting value to each image property item such that the setting value that contradicts the image property item is not included in the input prompt.

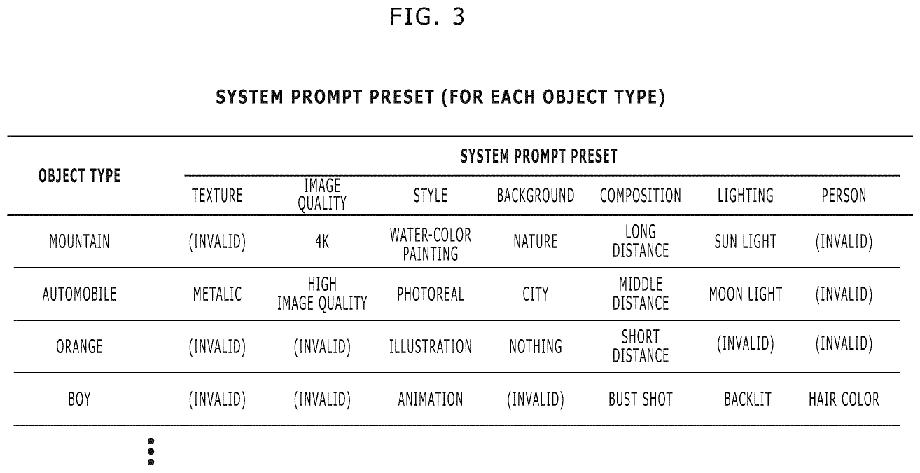

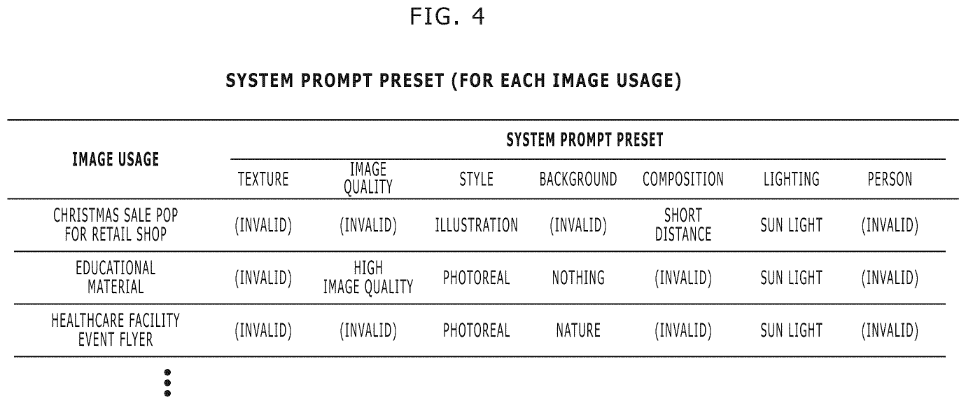

FIG. 3 shows a diagram that indicates an example of a system prompt preset for an object type. FIG. 4 shows a diagram that indicates an example of a system prompt preset for an image usage.

As shown in FIG. 3, for example, a system prompt preset for an object type is a data set that includes image property setting values that have been selected of plural image property items for this object type.

Further, as shown in FIG. 4, for example, a system prompt preset for an image usage is a data set that includes image property setting values (strings) that have been selected of plural image property items for this image usage.

Furthermore, the display device 14 is a device that displays an operation screen, a generated image mentioned below and the like, such as liquid crystal display. The input device 15 is a device that detects a user operation, such as hard key and/or touch panel.

Here, the processor 11 executes a program stored in the storage device 13 and thereby acts as a user prompt acquiring unit 21, a system prompt selecting unit 22, an input prompt generating unit 23, a generated image acquiring unit 24, and a system prompt managing unit 25.

The user prompt acquiring unit 21 acquires a user prompt (a string such as text) inputted by a user using the input device 15. Further, the user prompt acquiring unit 21 detects a string of an object type in the user prompt.

The system prompt selecting unit 22 selects a system prompt preset for an image usage specified by a user. Further, the system prompt selecting unit 22 selects a system prompt preset for an object type as a string detected in the user prompt.

The input prompt generating unit 23 generates an input prompt on the basis of the aforementioned user prompt and the image property setting values in the selected system prompt preset.

In this embodiment, the input prompt generating unit 23 generates an input prompt on the basis of the aforementioned user prompt, the image property setting values in the selected system prompt preset for the image usage, and the image property setting values in the selected system prompt preset for the object type.

Here, the user prompt acquiring unit 21 detects a string of an image property in the acquired user prompt, and when the detected string and the image property setting value in the selected system prompt preset for the image usage or the object type conflict with each other, the input prompt generating unit 23 generates the input prompt by preferentially using the detected string. Further, when the image property setting value in the selected system prompt preset for the image usage and the image property setting value in the selected system prompt preset for the object type conflict with each other, the input prompt generating unit 23 generates the input prompt by preferentially using the image property setting value in the selected system prompt preset for the image usage.

For example, if a string “beautiful mountain like an illustration” is inputted as a user prompt, parsing of the string is performed and thereby the string is divided to three strings “like an illustration”, “beautiful”, and “mountain”, and a noun among these strings, i.e. “mountain” is determined as an object type. Further, from “like an illustration” and “beautiful”, a modifier “illustration” registered in the system prompt definition data 13a is detected as a string of an image property.

Subsequently, the system prompt preset of the object type “mountain” is selected in the system prompt preset data 13b.

In the system prompt preset of the object type “mountain”, the setting value of the item “style” is “water-color painting”, and therefore it conflicts with “illustration” specified by the user prompt. In this case, the user prompt is more preferentially used than the system prompt preset, and therefore, as the setting value of the item “style”, “water-color painting” is not used but “illustration” is used. As mentioned, regarding an item of which setting values do not agree with each other, an item specified on the basis of a user prompt has the first priority, an item specified on the basis of a system prompt preset for an image usage has the second priority, and an item specified on the basis of a system prompt preset for an object type has the third priority. In this case, as an input prompt, “beautiful mountain, 4K, illustration, nature, long distance, sun light” is generated. As mentioned, “beautiful” in the user prompt (i.e. a string that is not found in the system prompt definition data 13a) may be included in the input prompt as is, or may be excluded from the input prompt.

The generated image acquiring unit 24 acquires a generated image corresponding to the aforementioned input prompt using an image generation model.

The image generation model is a learner that has been machine-learned in accordance with an existing method, and generates image data (i.e. a generated image) corresponding to the input prompt. The generated image acquiring unit 24 may include the image generation model, or using the communication device 12, may access an external server that the image generation model is installed, transmit the input prompt to the external server, and acquire a generated image from the external server.

The system prompt managing unit 25 generates system prompt preset data 13b that indicates the system prompt preset on the basis of the image usage or the object type specified by a user and the image property setting values, and stores the system prompt preset data 13b into the storage device 13. The system prompt selecting unit 22 reads the system prompt preset data 13b stored in the storage device 13 and thereby acquires the aforementioned selected system prompt preset.

Specifically, the system prompt managing unit 25 displays the system prompt definition data 13a as shown in FIG. 2, for example, of the image usage specified by a user or the object type specified by a user, and selects any setting value in the setting value candidate group for each image property item in accordance with a user operation to the input device 15 and thereby generates a system prompt preset for an image usage or an object type. It should be noted that “INVALID” in FIG. 2 is a setting value not to include any setting value of an image property item in a system prompt.

For example, if the object type “MOUNTAIN” is inputted as a string by a user, “(INVALID)” is selected of the item “texture”, “4K” is selected of the item “IMAGE QUALITY”, “WATAR-COLOR PAINTING” is selected of the item “STYLE,” “NATURE” is selected of the item “BACKGROUND”, “LONG DISTANCE” is selected of the item “COMPOSITION”, “SUN LIGHT” is selected of the item “LIGHTING”, and “(INVALID)” is selected of the item “PERSON”, then a system prompt preset of the object type “MOUNTAIN” is generated as shown in FIG. 3.

Further, the system prompt managing unit 25 may detect a string (noun) of an object type in a string such as text inputted by a user, search for a string of a setting value candidate registered in the system prompt definition data 13a, and generate a system prompt preset on the basis of the detected string of the object type and the string of the setting value candidate.

The following part explains a behavior of the prompt generating apparatus 1 in this embodiment.

### (a) Generation of an Input Prompt for Image Generation

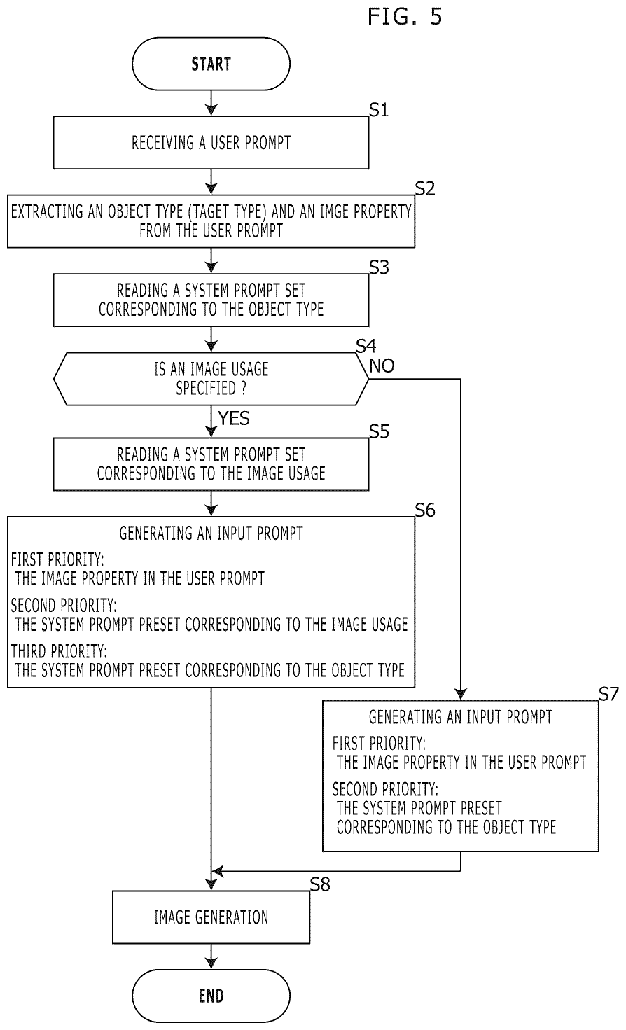

FIG. 5 shows a flowchart that explains generation of an input prompt for image generation in the prompt generating apparatus 1 shown in FIG. 1.

On the display device 14, the user prompt acquiring unit 21 displays a screen (dialog) that includes an input field of a user prompt and an image usage list (a list of image usages included in a system prompt preset registered in the system prompt preset data 13b) and detects as a user prompt a string inputted to the input field using the input device 15, and when one of the image usages is specified from the image usage list by a user operation, the user prompt acquiring unit 21 detects the specified image usage using the input device 15 (in Step S1).

Further, the user prompt acquiring unit 21 extracts a string of an object type and a string of an image property (modifier) from a string of the user prompt as mentioned (in Step S2).

Subsequently, the system prompt selecting unit 22 reads the system prompt preset data 13b, and selects a system prompt preset corresponding to the selected object type in the system prompt preset 13b (in Step S3).

Further, the system prompt selecting unit 22 determines whether an image usage was specified as mentioned or not (in Step S4), and if an image usage was specified, the system prompt selecting unit 22 selects a system prompt preset corresponding to the specified image usage in the system prompt preset data 13b (in Step S5).

Subsequently, the input prompt generating unit 23 generates an input prompt on the basis of (a) the acquired string of the image property in the user prompt, (b) the acquired system prompt preset corresponding to the object type, and (c) the acquired system prompt preset corresponding to the image usage (in Step S6).

Contrarily, if an image usage is not selected, the input prompt generating unit 23 generates an input prompt on the basis of (a) the acquired string of the image property in the user prompt and (b) the acquired system prompt preset corresponding to the object type (in Step S7).

Upon generating the input prompt as mentioned, the generated image acquiring unit 24 causes an image generation model to generate an image corresponding to the input prompt and acquires the generated image (image data) (in Step S8).

### (b) Registration of a System Prompt Preset

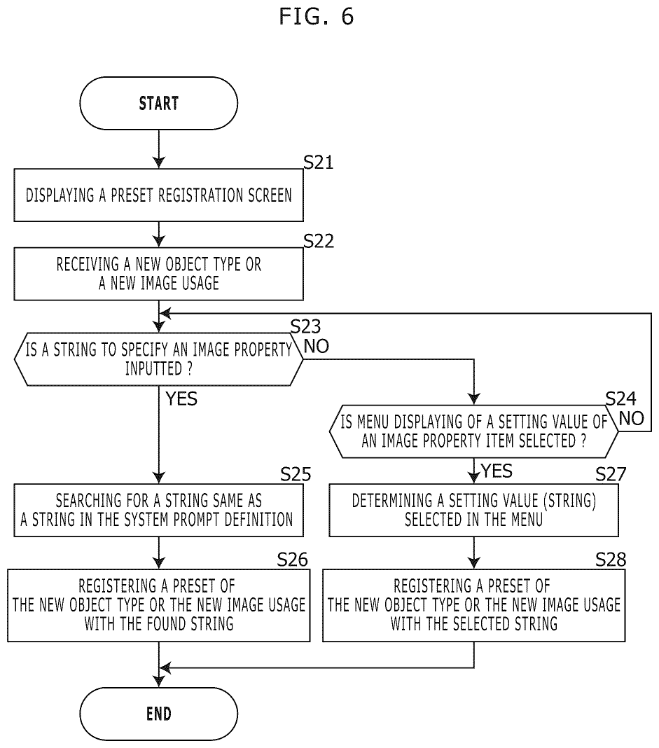

FIG. 6 shows a flowchart that explains registration of a system prompt preset in the prompt generating apparatus 1 shown in FIG. 1.

On the display device 14, the system prompt managing unit 25 displays a screen (dialog) that includes an input field (first input field) of a new object type or a new image usage, individual input fields (second input fields) of plural image property items, and an input field (third input field) to input setting values as a string in a natural language of plural image property items (in Step S21). The second input field of the aforementioned setting value has a menu such as pulldown menu in which a list of setting value candidates are displayed, and the setting value can be selected in the menu.

Subsequently, the system prompt managing unit 25 detects a string of a new object type or a new image usage inputted to the aforementioned input field using the input device 15 (in Step S22).

Further, the system prompt managing unit 25 determines whether input of a string to the third input field is detected by the input device 15 or not (in Step S23), and determines whether a selection operation to the second input field is detected by the input device 15 or not (in Step S24).

If input of a string to the third input field is detected by the input device 15, then the system prompt managing unit 25 searches this string for a string same as a setting value candidate registered in the system prompt definition data 13a (in Step S25), and generates a system prompt preset of the string of the aforementioned input field of the new object type or the new image usage with the found string in the search as an image property setting value and registers the generated system prompt preset to the system prompt preset data 13b (in Step S26).

If a selection operation to the second input field is detected by the input device 15, then the system prompt managing unit 25 determines the selected setting value candidate as an image property setting value (in Step S27), and generates a system prompt preset of the string of the aforementioned input field of the new object type or the new image usage with this image property setting value and registers the generated system prompt preset to the system prompt preset data 13b (in Step S28).

As mentioned, in the aforementioned embodiment, the user prompt acquiring unit 21 acquires a user prompt inputted by a user. The system prompt selecting unit 22 selects a system prompt preset for an image usage specified by the user among system prompt presets that include image property setting values that have been selected of plural image property items for specific image usages. The input prompt generating unit 23 generates an input prompt on the basis of the user prompt and the image property setting values in the selected system prompt preset. The generated image acquiring unit 24 acquires a generated image corresponding to the input prompt using an image generation model.

Consequently, a proper adjustment prompt to be inputted to an image generation model is automatically provided with simple user operations, that are, input of a user prompt and selection of an image usage.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned embodiment, a system prompt preset for an image usage may be selected without selecting a system prompt preset for an object type.

What is claimed is:

1. A prompt generating apparatus, comprising:
a user prompt acquiring unit configured to acquire a user prompt inputted by a user;
a system prompt selecting unit configured to select a system prompt preset for an image usage specified by the user among system prompt presets that include image property setting values that have been selected of plural image property items for specific image usages;
an input prompt generating unit configured to generate an input prompt on the basis of the user prompt and the image property setting values in the selected system prompt preset; and
a generated image acquiring unit configured to acquire a generated image corresponding to the input prompt using an image generation model.

2. The prompt generating apparatus according to claim 1, wherein the user prompt acquiring unit detects a string of an image property in the user prompt; and
when the detected string and the image property setting value in the selected system prompt preset conflict with each other, the input prompt generating unit generates the input prompt by preferentially using the detected string.

3. The prompt generating apparatus according to claim 1, wherein the system prompt selecting unit (a) selects a system prompt preset for an image usage specified by the user, (b) detects a string of an object type in the user prompt and selects a system prompt preset for the object type of the detected string among system prompt presets that include image property setting values that have been selected of plural image property items for specific image usages; and
the input prompt generating unit generates an input prompt on the basis of the user prompt, the image property setting values in the selected system prompt preset for the image usage, and the image property setting values in the selected system prompt preset for the object type.

4. The prompt generating apparatus according to claim 3, wherein the user prompt acquiring unit detects a string of an image property in the user prompt;
when the detected string and the image property setting value in the selected system prompt preset for the image usage or the object type conflict with each other, the input prompt generating unit generates the input prompt by preferentially using the detected string; and
when the image property setting value in the selected system prompt preset for the image usage and the image property setting value in the selected system prompt preset for the object type conflict with each other, the input prompt generating unit generates the input prompt by preferentially using the image property setting value in the selected system prompt preset for the image usage.

5. The prompt generating apparatus according to claim 1, further comprising a system prompt managing unit;
wherein the system prompt managing unit generates system prompt preset data that indicates the system prompt preset on the basis of the image usage or the object type specified by a user and an image property setting value, and stores the system prompt preset data into a storage device; and
the system prompt selecting unit reads the system prompt preset data stored in the storage device and thereby acquires the selected system prompt preset.
